(19) United States
(12) Patent Application Publication
(10) Pub. No.: US 2011/0282665 A1
(43) Pub. Date: Nov. 17, 2011

(54) METHOD FOR MEASURING ENVIRONMENTAL PARAMETERS FOR MULTI-MODAL FUSION

(75) Inventors: Hye Jin KIM, Daejeon (KR); Do Hyung KIM, Daejeon (KR); Su Young CHI, Daejeon (KR); Jae Yeon LEE, Daejeon (KR)

(73) Assignee: Electronics and Telecommunications Research Institute, Daejeon (KR)

(21) Appl. No.: 13/017,582

(22) Filed: Jan. 31, 2011

(30) Foreign Application Priority Data
May 11, 2010 (KR) 10-2010-0044142

(51) Int. Cl. G10L 17/00; G06K 9/00; G06K 9/68

(52) U.S. Cl. 704/246; 382/218; 382/115; 704/E17.001

(57) ABSTRACT

Provided is a method for measuring environmental parameters for multi-modal fusion. The method for measuring environmental parameters for multi-modal fusion, includes: preparing at least one enrolled modality; receiving at least one input modality; calculating image related environmental parameters of input images in at least one input modality based on illumination of enrolled image in at least one enrolled modality; and comparing the image related environmental parameters with a predetermined reference value and discarding the input image or outputting it as a recognition data according to the comparison result.

### CROSS-REFERENCE TO RELATED APPLICATIONS

This application claims priority under 35 U.S.C. §119 to Korean Patent Application No. 10-2010-0044142 filed on May 11, 2010, in the Korean Intellectual Property Office, the disclosure of which is incorporated herein by reference in its entirety.

### TECHNICAL FIELD

The present invention relates to a method for measuring environmental parameters for multi-modal fusion.

### BACKGROUND

A multi-modal fusion user recognition method according to the related art has mainly used methods for fusing a plurality of multi-modal information with recognition rate or features. When the purpose of the fusion is to acquire better performance by combining several data, the environments where the recognition rate is degraded may be different in consideration of each sensible aspect of a human body, that is, modality data. For example, in the case of the recognition rate, the recognition rate is lowered under the conditions such as backlight and in the case of the recognition rate of a speaker, the recognition rate is lowered under the condition of when a signal-to-noise ratio (SNR) is high.

As such, in recognizing the user, the environment where the recognition rate is lowered has been known well. However, it is impossible to increase the recognition performance of the user by referring to the environmental parameters in the user recognition system. The reason is that it is difficult to measure the environment, which changes every minute, when recognizing the user as parameters affecting the recognition rate.

### SUMMARY

It is an object of the present invention to provide a method for measuring environmental parameters for multi-modal fusion capable of measuring reliability of input images, input voice, or both thereof in real time in real environment.

An exemplary embodiment of the present invention provides a method for measuring environmental parameters for multi-modal fusion includes: preparing at least one enrolled modality; receiving at least one input modality; calculating image related environmental parameters of input images in at least one input modality based on illumination of enrolled image in the at least one enrolled modality; and comparing the image related environmental parameters with a predetermined reference value and discarding the input image or outputting it as a recognition data according to the comparison result.

Another embodiment of the present invention provides a method for controlling environmental parameters for multi-modal fusion includes: preparing enrolled voice for user recognition; receiving input voice for user recognition; extracting voice related environmental parameters for the input voice based on the enrolled voice; and comparing the extracted voice related environmental parameters with a predetermined reference value and discarding the input image or outputting it as a recognition data according to the comparison result.

Yet another embodiment of the present invention provides a method for measuring environmental parameters for multi-modal fusion includes: preparing an enrolled image and an enrolled voice for user recognition; receiving each of an input image and an input voice for the user recognition; extracting an image related environmental parameter for the input image based on the enrolled image; extracting a voice related environmental parameter for the input voice based on the enrolled voice; and comparing each of the extracted image related environmental parameter and voice related environmental parameter with a predetermined reference value and discarding only the input image, only the input voice, or both of the input image and the input voice or outputting them as recognition data according to the comparison result.

Other features and aspects will be apparent from the following detailed description, the drawings, and the claims.

### BRIEF DESCRIPTION OF THE DRAWINGS

FIG. 1 is a flow chart of a method for measuring environmental parameters for multi-modal fusion according to an exemplary embodiment of the present invention;

FIG. 2 is a diagram showing an example of an enrolled face image useable in the method for measuring environmental parameters for multi-modal fusion of FIG. 1;

FIGS. 3A to 3F are diagrams for explaining a face recognition process for various input images in the method for measuring environmental parameters for multi-modal fusion of FIG. 1;

FIGS. 4A to 4F are diagrams for explaining brightness for various input images of FIGS. 3A to 3F;

FIGS. 5A to 5C are graphs for explaining BrightRate according to an illumination distance in the method for measuring environmental parameters for multi-modal fusion of FIG. 1; and

FIG. 6 is a graph showing a recognition error rate according to the BrightRate in the method for measuring environmental parameters for multi-modal fusion.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

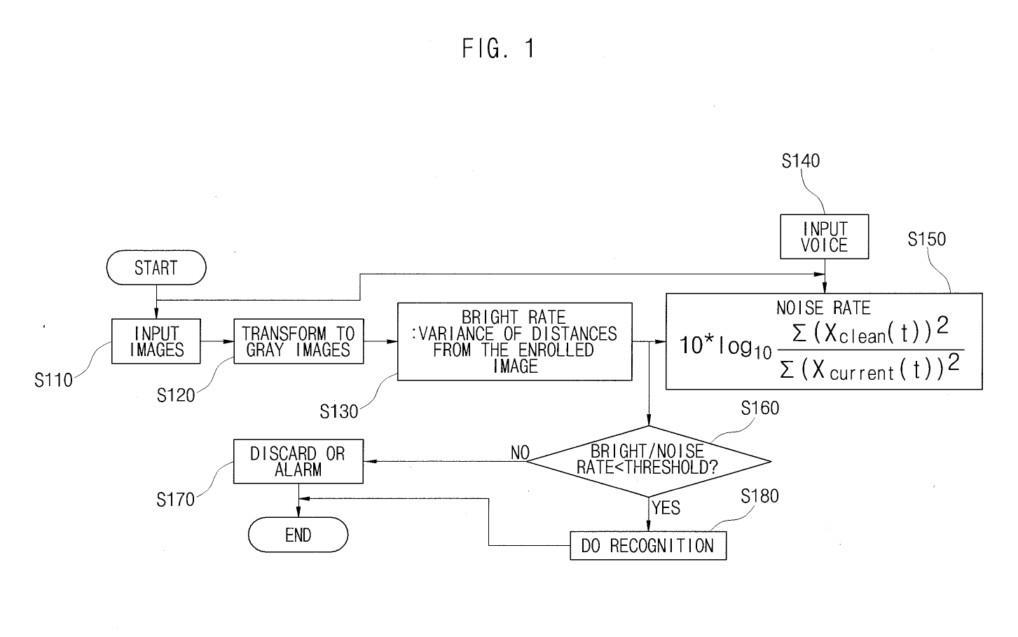

FIG. 1 is a flow chart of a method for measuring environmental parameters for multi-modal fusion according to an exemplary embodiment of the present invention.

In the following description, an apparatus for measuring environmental parameters basically measures environmental parameter for multi-modal fusion according to the exemplary embodiment and is referred to as an apparatus that includes a function capable of performing face recognition, speaker identification, or both of them based on the measured environmental parameters, or components including the functions. The input images, input voice, or both of them input to the apparatus for measuring environmental parameters may be referred as input modality.

Referring to FIG. 1, in a face recognition apparatus or a user recognition system (not shown; hereinafter, referred to as an apparatus for measuring environmental parameters) using a method for measuring environmental parameters according to the exemplary embodiment, if there are input images for face recognition (S110), the apparatus for measuring environmental parameters first transforms the input images into gray images (S120).

At step S120, transforming the input images into the gray images is to more accurately obtain variance of distance from the enrolled images for the input images in the following steps. In other words, this is to clearly classify the ratio of brightness or brightness region to input images based on the enrolled images.

Next, the apparatus for measuring environmental parameters obtains image related environmental parameters for input images based on the enrolled images (S130). In the present exemplary embodiment, the image related environmental parameters for the input images are referred to as “BrightRate.” BrightRate is represented by the following Equation 1.

BrightRate=variance(distNorm(Iₑₙᵣₒₗₗ,Iₜₑₛₜ) [Equation 1]

In Equation 1, Ienroll represents the enrolled images and Itest represents test images or input images. As represented in Equation 1, the apparatus for measuring environmental parameters according to the exemplary embodiment obtains a distance norm of the enrolled image Ienroll and a distance norm of the test image Itest, wherein the variance of the obtained distance norm value becomes the image related environmental parameters for the input images, that is, the BrightRate.

The above-mentioned distance norm may be calculated based on any one of all possible distance calculation methods, such as Absolute distance (1-norm distance), Euclidean distance (2-norm distance), Minkowski distance (p-norm distance), Chebyshev distance, Mahalanobis distance, Hamming distance, Lee distance, and Levenshtein distance.

Next, if there is an input voice for speaker identification (S140), the apparatus for measuring environmental parameters obtains voice related environmental parameters for input voice based on the enrolled voice (S150). In the present exemplary embodiment, the image related environmental parameters for the input images are referred to as “NoiseRate”. The NoiseRate is represented by the following Equation 2.

$$NoiseRate = 10 * log \frac{{\sum }_{ }^{ } {( {x}_{clean} ( t ) )}^{2}}{{( {x}_{current} ( t ) )}^{2}} \qquad [ Equation 2 ]$$

In Equation 2, Xclean(t) represents the enrolled voice or the target speech in the environment where the user is enrolled and Xcurrent(t) represents the input voice in any environment.

According to step S150, it is difficult to measure signal-to-noise ratio (SNR) but it can measure the environmental parameters of the input voice based on the target speech under the assumption that the input voice, that is, the target speech, is a pure signal at the time of the enrollment.

The method for measuring environmental parameters according to the exemplary embodiment may be an alternative method of a method using the SNR for speaker identification. In other words, since the SNR measurement is difficult to identify whether any period is a signal period and any period is a noise period, it is difficult to recognize the speaker recognition as the SNR measurement of the environment. However, since the NoiseRate according to the present exemplary embodiment measures the environmental parameters of the input voice under the assumption that the target speech is the pure signal at the time of the enrollment, it is easy to classify the signal period and the noise period.

Next, it is determined that each of is BrightRate and NoiseRate obtained from steps S130 and S150 or both of them are below a predetermined threshold (S160). When the threshold is BrightRate, the face recognizable input data may be set as the maximum threshold and when the threshold is NoiseRate, the speaker recognizable input data may be set as the maximum threshold. For example, the reference value may be set as 20 dB or less in the case of the NoiseRate when considering the limitation of the user identification.

Next, as a determination result of step S160, if the BrightRate, NoiseRate, or both of them are larger than the reference value, it is informed to the user that the corresponding input data are discarded or cannot be used, or the like, (S170).

In addition, the determination result of step S160, if BrightRate, NoiseRate, or both of them is equal to or less than the reference value, the corresponding input data is transferred to a unit performing the face recognition or a unit performing the speaker identification and are used as the data for user identification (S180). For example, the data for user identification may include feature extraction for a normalized face, a normalized voice, or both of them.

As described above, according to the exemplary embodiment of the present invention, the environmental parameters for input modality for face recognition or speaker identification are measured based on the enrolled modality, such that the reliability for the input data can be rapidly determined and the performance of the user recognition system can be improved.

As described above, in the exemplary embodiment of the present invention, there is provided a method for efficiently mixing multi-modal information by applying the environmental parameters based on the enrolled user recognition information. The main feature of the present algorithm is based on the fact that specific environmental conditions can cause lower accuracy for specific modality while the remaining modality does not affect the conditions. In addition, the present exemplary embodiment is based on the fact that the speaker identification, the face recognition, or both of them use the enrollment step. In other words, one of the main technical features of the exemplary embodiment differentially selects the reliable features based on the environmental parameters as a result of processing combined audio-visual.

Hereinafter, real various input images according to the above-mentioned embodiments will be described in more detail by way of example.

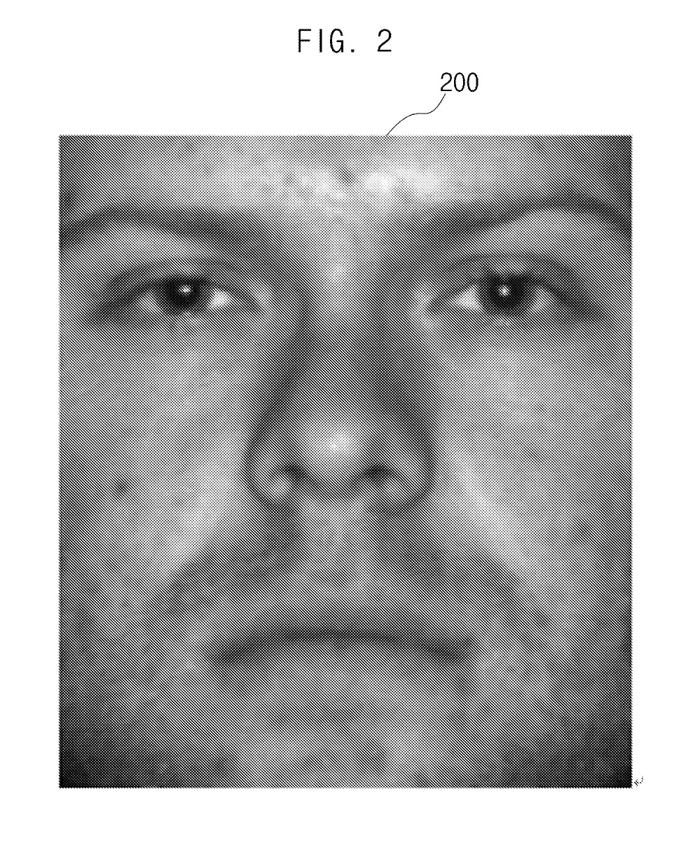

FIG. 2 is a diagram showing an example an enrolled face image useable in the method for measuring environmental parameters for multi-modal fusion of FIG. 1.

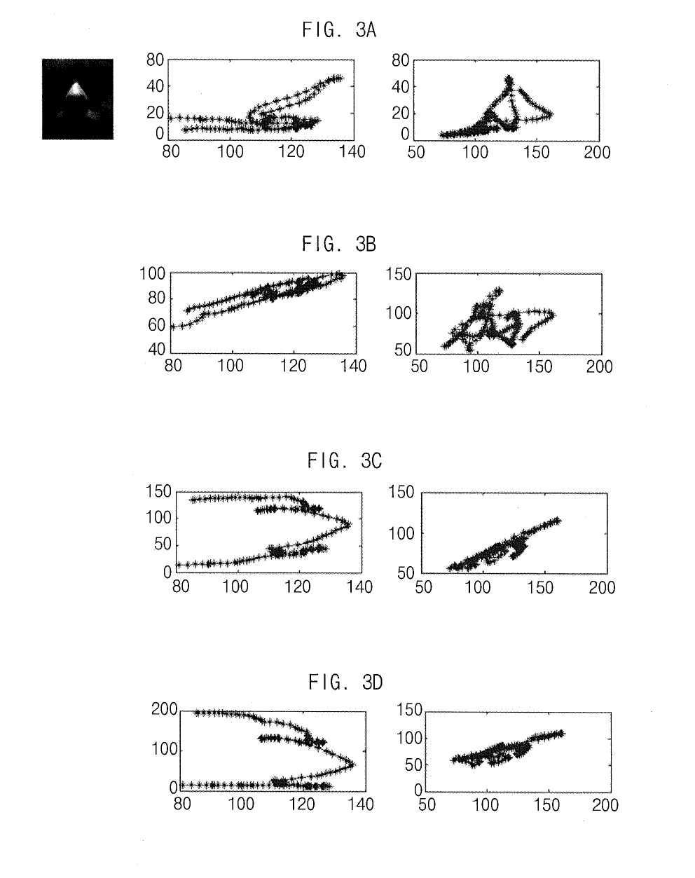

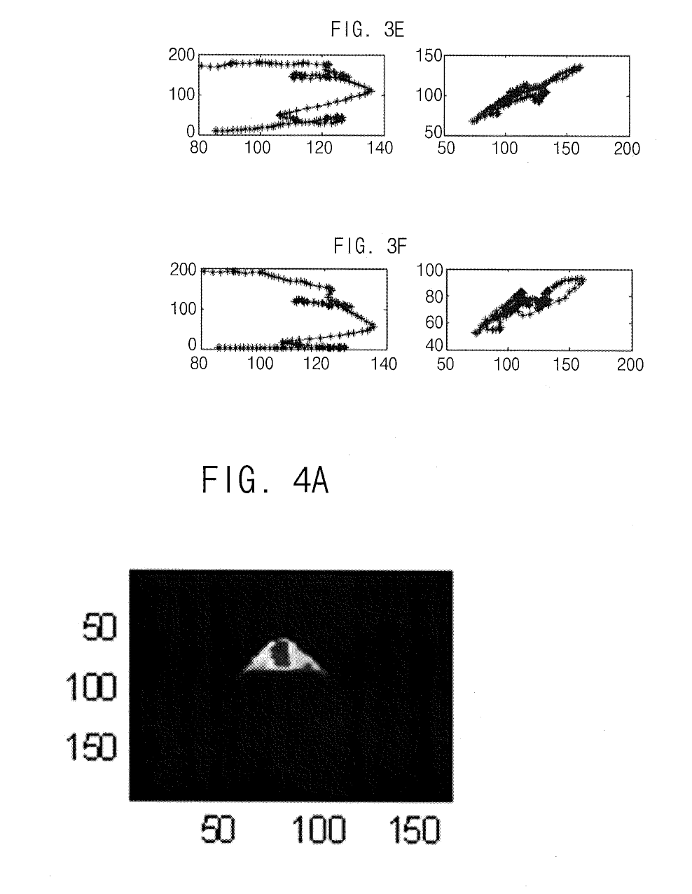

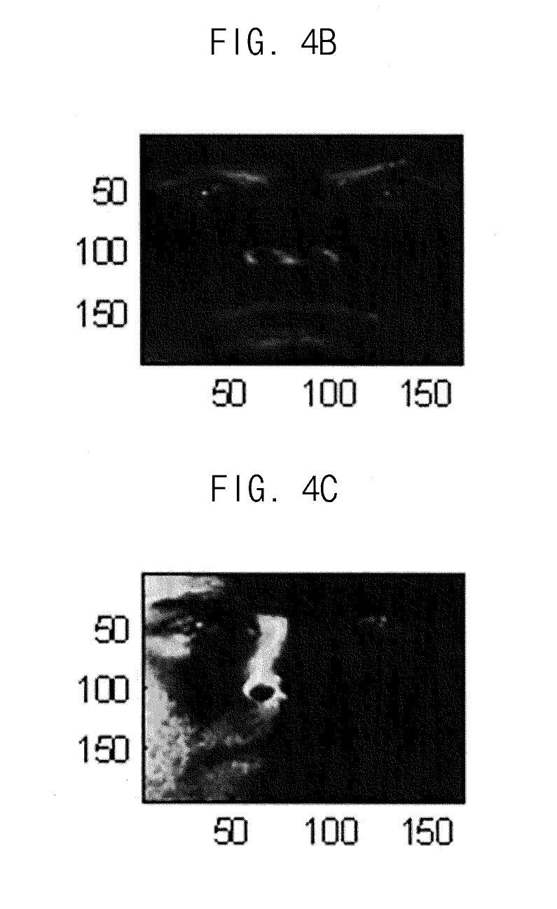

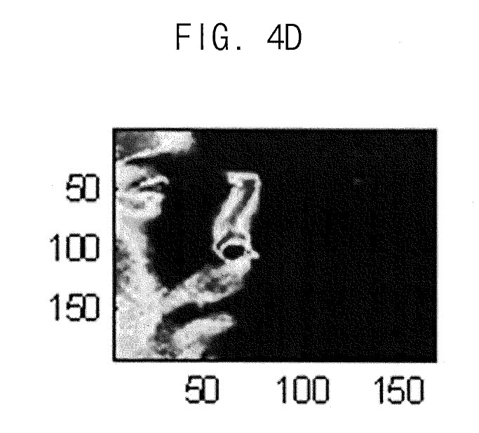

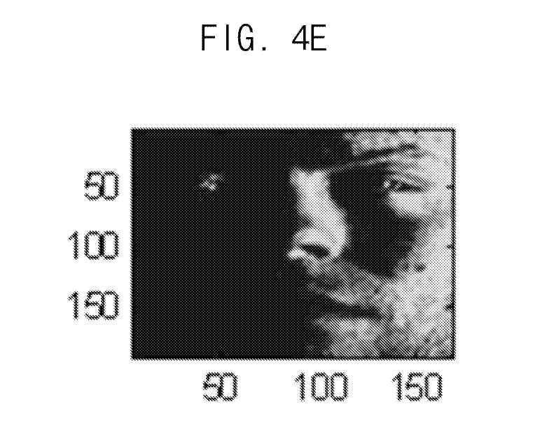

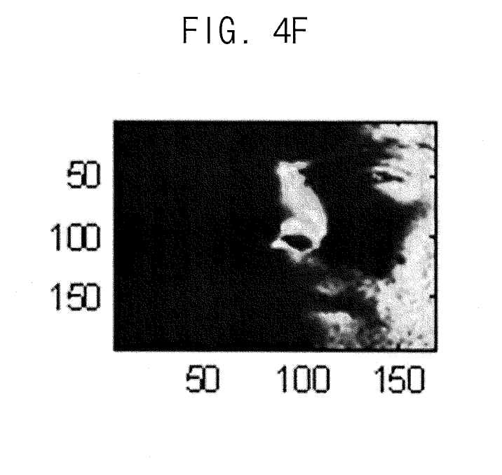

FIGS. 3A to 3F are diagrams for explaining a face recognition process for various input images in the method for measuring environmental parameters for multi-modal fusion of FIG. 1. FIGS. 4A to 4F are diagrams for explaining brightness for various input images of FIGS. 3A to 3F.

Face images shown in FIGS. 2, 3A to 3F, and 4A to 4F are obtained from a Yaeil-B database. The Yaeil-B database includes face images whose illumination is changed in several directions. In addition, the Yaeil-B database includes gray images. Each image of FIGS. 4A to 4F corresponds to images of a first left column of (a) to (f) lines of FIGS. 3A to 3F.

The gray images shown in the first left column of FIGS. 3A to 3F may correspond to the gray images of a second step (S120) of FIG. 1. Each of the second and third column images of FIGS. 3A to 3F represents relative brightness of an X-axis and a Y-axis for a normal input image of FIG. 2, that is, the enrolled image 200. In the present embodiment, the normal input image of FIG. 2 is assumed to be the enrolled image 200.

If the illumination of the input image is the same or similar to the illumination of the enrolled image, the slope of the illumination line of the input image approximates the slope of the illumination line of the enrolled image.

Therefore, if the BrightRate is larger than the threshold that is a maximum value of the image recognition reference, the input image is discarded and the user can be ordered or requested to prepare the input images by changing the light condition in order to input new images.

In FIGS. 3A to 3F, the image of the first line (a) in the first column is very dark and thus, all the pixels other than pixels around a nose approaches black. In the present exemplary embodiment, the image of the first line (a) may be regarded.

The image of the second line (b) has an approximately uniformed illumination change. In other words, the image of the second line (b) has an approximately uniformed illumination change in the X-axis and the Y-axis directions. Therefore, the BrightRate value for the image of the second line (b) is relatively small, such that it can be appreciated that the reliability of the corresponding input image is higher relative to other images.

The images of the third line (c) and the fifth line (e) are more affected by the light change of the horizontal direction than the light change of the vertical direction. Therefore, each of the images of the third line (c) and the fifth line (e) has the BrightRate value in the horizontal direction larger than the BrightRate in the vertical direction.

The images of the fourth line (d) and the sixth line (f) are affected by the light change in the horizontal direction. In other words, the images of the fourth line (d) and the sixth line (f) have the BrightRate value in the horizontal direction larger than the BrightRate value in the horizontal direction of the images of the corresponding third line (c) and the fifth line (e). Therefore, the BrightRate value for the images of the fourth line (d) and the sixth line (f) is larger than the BrightRate value for the images of the third line (c) and the fifth line (e), such that it can be appreciated that the reliability of the images of the fourth line (d) and the sixth line (f) is lower than the reliability of the images of the third line (c) and the fifth line (e).

As described above, in the exemplary embodiment of the present invention, the new concept, that is, the BrightRate is provided as the variance of the distance between the enrolled image and the tested image (or input image). The BrightRate normalizes and displays the relative change of the input image as the maximum distance according to at least the illumination based on the enrolled image. Therefore, the reliability of the input image can be easily determined.

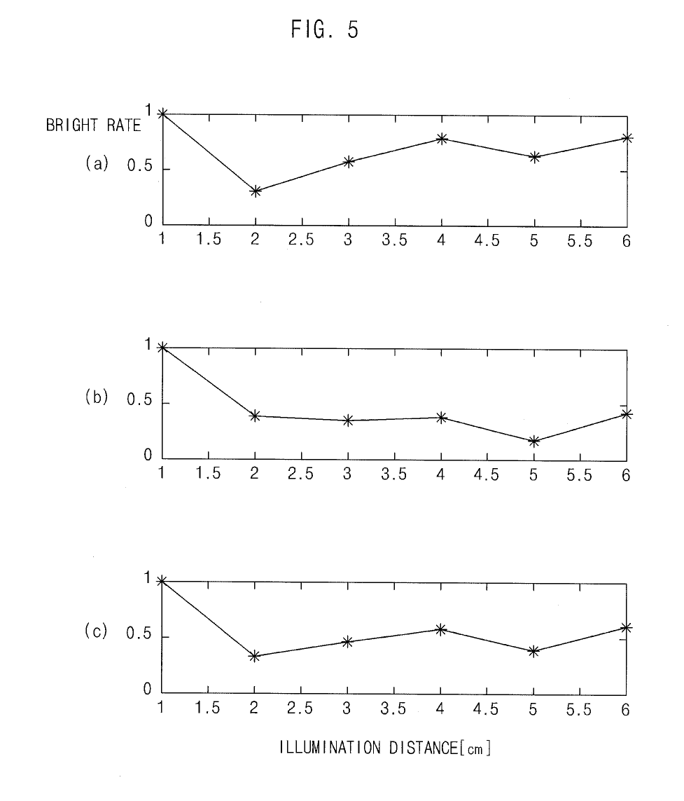

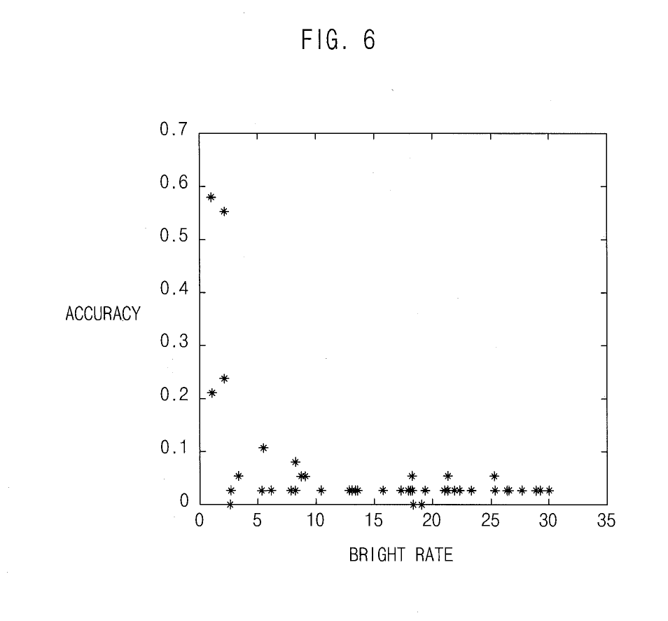

FIGS. 5A to 5C are graphs for explaining the BrightRate according to the illumination distance in the method for measuring environmental parameters for multi-modal fusion of FIG. 1. FIG. 6 is a graph showing a recognition error rate according to the bright rate in the method for measuring environmental parameters for multi-modal fusion of FIG. 1.

In FIGS. 5A to 5C, a vertical axis represents the BrightRate, and a horizontal axis represents the illumination distance. FIG. 5A shows the change in the x-axis direction, FIG. 5B shows the change in the y-axis direction, and FIG. 5C shows the change in both directions of the x-axis and the y-axis.

As shown in FIGS. 5A to 5C, the BrightRate has a large value when the illumination distance is smaller than about 1.5 m and as shown in FIG. 6, when the BrightRate is high, it can be appreciated that the error rate is high in recognizing a face.

Meanwhile, in the current environment that can obtain images of 30 or more per 1 second and regularly turn-on or off the lighting device, there is no need to perform face recognition by using the input image of the worst conditions. Therefore, the reliability of the input data for the user recognition can be easily determined by measuring the difference or the variance in the illumination rate or the illumination area of the input image in real time based on the enrolled image.

According to the above-mentioned exemplary embodiments, both of the BrightRate and the NoiseRate are used, such that the multi-modal recognition rate can be increased even in the case of considering the peripheral noise and the peripheral light.

As described above, the exemplary embodiment normalizes the input face image based on the environmental parameters of the pre-enrolled reference image without determining the direction of light or separately correcting a shadow, the noise component of the actually input image is removed in real time and the face recognition for the input image can be effectively performed therefrom.

In addition, in recognizing the voice in the method similar to the above-mentioned face recognition, the input voice data is normalized based on the environmental parameters of the pre-enrolled reference data such that the noise component of the actually input voice is removed in real time and the speaker recognition for the input voice can be effectively performed therefrom. In addition, the error rate of the user recognition can be remarkably lowered by fusing the environmental parameters for the above-mentioned face recognition and the environmental parameters for the voice recognition. Further, according to the description of the present exemplary embodiment, in the multi-modal fusion of the user recognition, the measured quality of images, voice, or both thereof in real time in real environment can be used as the weights or the parameters. This is increasing the reliability of the input information. Therefore, the processing speed or performance of the user recognition system can be improved.

According to the exemplary embodiments of the present invention, the method for measuring environmental parameters for multi-modal fusion capable of measuring the quality of images, voice, or both thereof in real time in real environment can be provided. In other words, unlike the existing method that directly measures the environments, the measured quality can be used as the weights or the parameters for user recognition in the multi-modal fusion since the user environment of the input recognition data are measured in real time based on the enrolled user recognition information. Thus, the method of providing reliable quality of input data in the user recognition can be provided. In addition, in the case of very bad input data, since it can discard the input recognition data or simply determine the input of new recognition data, it can be usefully used to improve the speed of the system or to prevent unnecessary operation from being performed, etc., in the user recognition system that can be interacted.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method for measuring environmental parameters for multi-modal fusion, comprising:
preparing at least one enrolled modality;
receiving at least one input modality;
calculating image related environmental parameters of input images in at least one input modality based on illumination of enrolled image in at least one enrolled modality; and
comparing the image related environmental parameters with a predetermined reference value and discarding the input image or outputting it as a recognition data according to the comparison result.

2. The method of claim 1, further comprising transforming the input image into a gray image.

3. The method of claim 2, wherein the calculating obtains a distance norm between the enrolled image and the input image.

4. The method of claim 3, the distance norm includes absolute distance (1-norm distance), Euclidean distance (2-norm distance), Minkowski distance (p-norm distance), Chebyshev distance, Mahalanobis distance, hamming distance, Lee distance, Levenshtein distance or a combination thereof.

5. The method of claim 1, wherein the enrolled modality includes the enrolled image that is a comparison reference of the input image for user recognition and the enrolled voice that is a comparison reference of the input voice as another input modality.

6. The method of claim 5, further comprising obtaining a voice related environmental parameter (NoiseRate) by the following Equation 2 for the input voice.
$$NoiseRate = 10 * log \frac{{\sum }_{ }^{ } {( {x}_{clean} ( t ) )}^{2}}{{( {x}_{current} ( t ) )}^{2}} \qquad [ Equation 2 ]$$
(where Xclean(t) represents the enrolled voice in the environment that registers the user and Xcurrent(t) represents the input voice in any environment).

7. A method for controlling environmental parameters for multi-modal fusion, comprising:
preparing enrolled voice for user recognition;
receiving input voice for the user recognition;
extracting voice related environmental parameters for the input voice based on the enrolled voice; and
comparing the extracted voice related environmental parameters with a predetermined reference value and discarding the input image or outputting it as a recognition data according to the comparison result.

8. The method of claim 7, further comprising obtaining a voice related environmental parameter (NoiseRate) by the following Equation 2.
$$NoiseRate = 10 * log \frac{{\sum }_{ }^{ } {( {x}_{clean} ( t ) )}^{2}}{{( {x}_{current} ( t ) )}^{2}} \qquad [ Equation 2 ]$$
(where Xclean(t) represents the enrolled voice in the environment that enrolls the user and Xcurrent(t) represents the input voice in any environment).

9. The method of claim 7, wherein the preparing prepares the enrolled voice in an SNR environment of 20 dB or more.

10. A method for measuring environmental parameters for multi-modal fusion, comprising:
preparing an enrolled image and an enrolled voice for user recognition;
receiving each of an input image and an input voice for the user recognition;
extracting an image related environmental parameter for the input image based on the enrolled image;
extracting a voice related environmental parameter for the input voice based on the enrolled voice; and
comparing each of the extracted image related environmental parameter and voice related environmental parameter with a predetermined reference value and discarding only the input image, only the input voice, or both of the input image and the input voice or outputting them as a recognition data according to the comparison result.

11. The method of claim 10, further comprising transforming the input image into a gray image.

12. The method of claim 10, wherein the extracting the image related environmental parameter for the input image calculates a distance norm between the enrolled image and the input image by the following Equation 1.
BrightRate=variance(distNorm(Iₑₙᵣₒₗₗ,Iₜₑₛₜ) [Equation 1]
(where, Ienroll represents an enrolled image, Itest represents a tested image or the input image, variance of the calculated distance norm value represents BrightRate that is an environmental parameter for the input image).

13. The method of claim 12, wherein the distance norm includes absolute distance (1-norm distance), Euclidean distance (2-norm distance), Minkowski distance (p-norm distance), Chebyshev distance, Mahalanobis distance, hamming distance, Lee distance, Levenshtein distance or a combination thereof.

14. The method of claim 10, wherein the extracting the voice related environmental parameter for the input voice further includes obtaining the voice related environmental parameter (NoiseRate) by the following Equation 2.
$$NoiseRate = 10 * log \frac{{\sum }_{ }^{ } {( {x}_{clean} ( t ) )}^{2}}{{( {x}_{current} ( t ) )}^{2}} \qquad [ Equation 2 ]$$
(where Xclean(t) represents the enrolled voice in the environment that enrolls the user and Xcurrent(t) represents the input voice in any environment).

15. The method of claim 14, wherein the preparing prepares the enrolled voice in the SNR environment of 20 dB or more.
